(19) United States
(12) Patent Application Publication
(10) Pub. No.: US 2011/0279690 A1
(43) Pub. Date: Nov. 17, 2011

(54) ELECTRONIC DEVICE, CAMERA, AND COMPUTER PROGRAM PRODUCT OF IMAGE PROCESSING

(75) Inventors: Toshihisa KUROIWA, Miura-shi (JP); Hiroki UWAI, Yokohama-shi (JP)

(73) Assignee: NIKON CORPORATION, Tokyo (JP)

(21) Appl. No.: 13/027,698

(22) Filed: Feb. 15, 2011

(30) Foreign Application Priority Data
Feb. 25, 2010 (JP) 2010-040380

(51) Int. Cl. H04N 5/225; H04N 5/76

(52) U.S. Cl. 348/207.2; 348/231.2; 348/E05.024

(57) ABSTRACT

An electronic device includes: a specifying unit that specifies image data to be designated as a print target; an image generation unit that generates a single image as a print target image based upon a plurality of sets of image data when the specifying unit specifies as the print target a set of image data contained in a first image file that includes the plurality of sets of image data for constituting the single image; an image file generation unit that generates a second image file containing the print target image having been generated by the image generation unit; an image file recording unit that records the second image file having been generated by the image file generation unit, into a storage medium; and a print information recording unit that generates print information to be used when printing the print target image and records the print information into the storage medium.

### INCORPORATION BY REFERENCE

The disclosure of the following priority application is herein incorporated by reference: Japanese Patent Application No. 2010-040380 filed Feb. 25, 2010.

### BACKGROUND OF THE INVENTION

1. Field of the Invention

The present invention relates to an electronic device, a camera and an image processing program product.

2. Description of Related Art

There are image data recording devices known in the related art that record a plurality of sets of image data obtained through a single shooting operation, into a single image file (see, for instance, Japanese Laid Open Patent Publication No. H11-266420).

### SUMMARY OF THE INVENTION

However, an image in the image file recorded by the image data recording device in the related art cannot be printed on a printer that is not capable of handling an image file containing a plurality of images.

According to the 1st aspect of the present invention, an electronic device, comprises: a specifying unit that specifies image data to be designated as a print target; an image generation unit that generates a single image as a print target image based upon a plurality of sets of image data when the specifying unit specifies as the print target a set of image data contained in a first image file that includes the plurality of sets of image data for constituting the single image; an image file generation unit that generates a second image file containing the print target image having been generated by the image generation unit; an image file recording unit that records the second image file having been generated by the image file generation unit, into a storage medium; and a print information recording unit that generates print information to be used when printing the print target image and records the print information into the storage medium.

According to the 2nd aspect of the present invention, an electronic device, comprises: a specifying unit that specifies image data to be designated as a print target; an image generation unit that generates a single image as a print target image based upon a plurality of sets of image data when the specifying unit specifies as the print target a set of image data contained in a first image file which includes the plurality of sets of image data for constituting the single image; an image file generation unit that generates a second image file containing the print target image having been generated by the image generation unit; an image file recording unit that records the second image file having been generated by the image file generation unit, into a storage medium; and a print instruction unit that issues a print instruction so as to engage a printer device to print the print target image by transmitting the second image file having been recorded by the image file recording unit, to the printer device.

According to the 3rd aspect of the present invention, in the electronic device according to the 1st aspect, it is preferred that: the electronic device further comprises a setting unit that selects a setting indicating whether or not to generate the print target image based upon the plurality of sets of image data; and the image generation unit generates the print target image based upon the plurality of sets of image data when the setting unit selects a setting indicating that the print target image is to be generated, and the image generation unit designates the set of image data having been specified by the specifying unit as the print target image when the setting unit selects a setting indicating that the print target image is not to be generated.

According to the 4th aspect of the present invention, in the electronic device according to the 1st aspect, it is preferred that when the specifying unit has specified as the print target one of the plurality of sets of image data in the first image file, the image generation unit issues an inquiry to a user asking whether the user wishes to have the print target image generated based upon the plurality of sets of image data, generates the print target image based upon the plurality of sets of image data if the user allows generation of the print target image, and designates the set of image data having been specified by the specifying unit as the print target image if the user disallows generation of the print target image.

According to the 5th aspect of the present invention, in the electronic device according to the 1st aspect, it is preferred that the electronic device further comprises an image display unit that displays at a display device the print target image having been generated by the image generation unit.

According to the 6th aspect of the present invention, in the electronic device according to the 1st aspect, it is preferred that the image file recording unit generates the second image file after adjusting a size of the print target image in correspondence to a size of paper on which the print target image is to be printed.

According to the 7th aspect of the present invention, in the electronic device according to the 5th aspect, it is preferred that the image file recording unit generates the second image file after adjusting a size of the print target image in correspondence to display resolution of the display device.

According to the 8th aspect of the present invention, in the electronic device according to the 6th aspect, it is preferred that the electronic device further comprises an additional recording unit that additionally records image data expressing the print target image having undergone size adjustment into the first image file having been used as a generation source when generating the print target image.

According to the 9th aspect of the present invention, in the electronic device according to the 8th aspect, it is preferred that: a set of image data is recorded as a representative image in the first image file; and the additional recording unit records the image data expressing the print target image having undergone the size adjustment as the representative image.

According to the 10th aspect of the present invention, in the electronic device according to the 2nd aspect, it is preferred that: the electronic device further comprises a setting unit that selects a setting indicating whether or not to generate the print target image based upon the plurality of sets of image data; and the image generation unit generates the print target image based upon the plurality of sets of image data when the setting unit selects a setting indicating that the print target image is to be generated, and the image generation unit designates the set of image data having been specified by the specifying unit as the print target image when the setting unit selects a setting indicating that the print target image is not to be generated.

According to the 11th aspect of the present invention, in the electronic device according to the 2nd aspect, it is preferred that when the specifying unit has specified as the print target one of the plurality of sets of image data in the first image file, the image generation unit issues an inquiry to a user asking whether the user wishes to have the print target image generated based upon the plurality of sets of image data, generates the print target image based upon the plurality of sets of image data if the user allows generation of the print target image, and designates the set of image data having been specified by the specifying unit as the print target image if the user disallows generation of the print target image.

According to the 12th aspect of the present invention, in the electronic device according to the 2nd aspect, it is preferred that the electronic device further comprises an image display unit that displays at a display device the print target image having been generated by the image generation unit.

According to the 13th aspect of the present invention, in the electronic device according to the 2nd aspect, it is preferred that the image file recording unit generates the second image file after adjusting a size of the print target image in correspondence to a size of paper on which the print target image is to be printed.

According to the 14th aspect of the present invention, in the electronic device according to the 12th aspect, it is preferred that the image file recording unit generates the second image file after adjusting a size of the print target image in correspondence to display resolution of the display device.

According to the 15th aspect of the present invention, in the electronic device according to the 13th aspect, it is preferred that the electronic device further comprises an additional recording unit that additionally records image data expressing the print target image having undergone size adjustment into the first image file having been used as a generation source when generating the print target image.

According to the 16th aspect of the present invention, in the electronic device according to the 15th aspect, it is preferred that: a set of image data is recorded as a representative image in the first image file; and the additional recording unit records the image data expressing the print target image having undergone the size adjustment as the representative image.

According to the 17th aspect of the present invention, a camera comprises: an image acquisition unit that obtains image data by capturing a subject image; and an electronic device according to the 1st aspect.

According to the 18th aspect of the present invention, a camera comprises: an image acquisition unit that obtains image data by capturing a subject image; and an electronic device according to the 2nd aspect.

According to the 19th aspect of the present invention, an electronic device comprises: a specifying unit that specifies image data; an image generation unit that generates a single image based upon a plurality of sets of image data when the specifying unit specifies a set of image data contained in a first image file that includes the plurality of sets of image data for constituting the single image; an image file generation unit that generates a second image file containing the image having been generated by the image generation unit; and an image file recording unit that records the second image file having been generated by the image file generation unit, into a storage medium.

According to the 20th aspect of the present invention, a computer program product enables a computer to execute: a specifying step of specifying image data; an image generation step of generating a single image based upon a plurality of sets of image data when one set of image data contained in a first image file that includes the plurality of sets of image data for constituting the single image, is specified through the specifying step; an image file generation step of generating a second image file containing the image having been generated through the image generation step; and an image file recording step of recording the second image file having been generated through the image file generation step into a storage medium.

### BRIEF DESCRIPTION OF THE DRAWINGS

FIG. 1 is a block diagram, showing the structure adopted in an embodiment of the digital still camera (DSC).

FIG. 2 schematically illustrates a data structure that may be assumed in an MP file.

FIG. 3 is a first diagram illustrating how image files may be recorded in the memory card 110a.

FIG. 4 presents a specific example of a print instruction screen.

FIGS. 5A through 5C each present a specific example of a panoramic image.

FIG. 6 presents a flowchart of the print processing executed in a first embodiment.

FIG. 7 presents a flowchart of the print processing executed in a second embodiment.

FIG. 8 presents a flowchart of the reproduction processing executed in a third embodiment.

FIG. 9 illustrates how programs may be provided.

### DESCRIPTION OF PREFERRED EMBODIMENTS

### First Embodiment

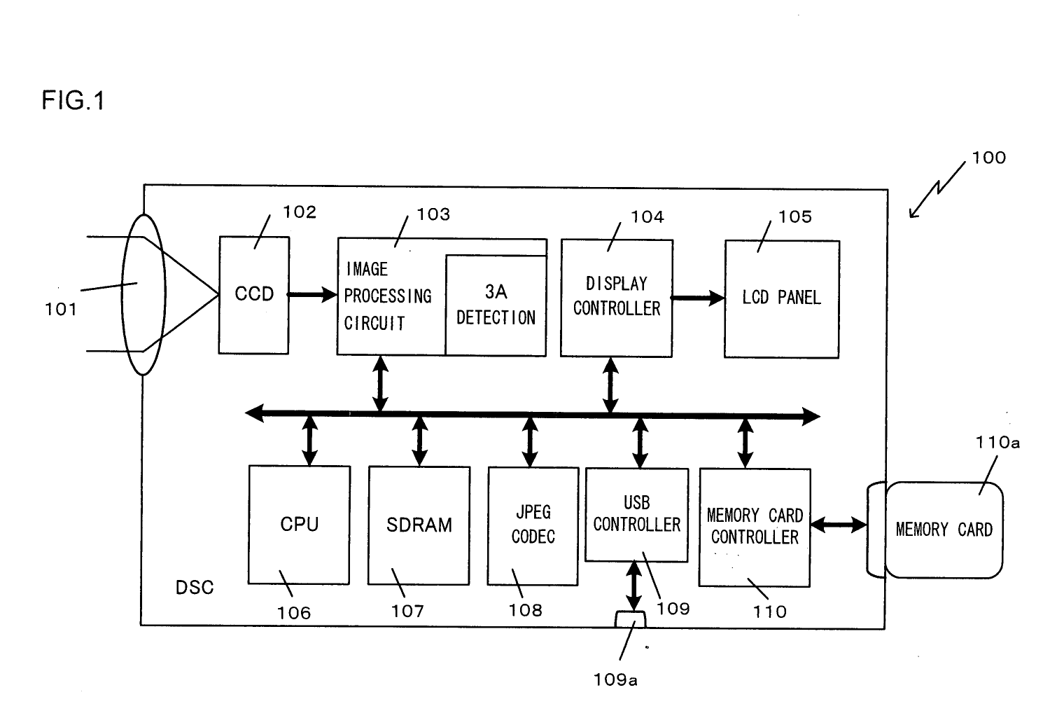

FIG. 1 is a block diagram showing a structure that may be adopted in the digital still camera (DSC) achieved in the first embodiment. A digital still camera (hereafter referred to as a “digital camera”) 100 comprises a lens 101, a CCD 102, an image processing circuit 103, a display controller 104, an LCD panel 105, a CPU 106, an SDRAM 107, a JPEG codec 108, a USB controller 109 and a memory card controller 110.

The CPU 106 is a main controller that executes overall control for the digital camera 100 by executing photographing processing, image reproduction processing, image data transfer processing and the like.

The photographing processing executed in the digital camera 100 is first described. An optical image of a subject input through the lens 101 undergoes photoelectric conversion at the CCD 102 functioning as an image sensor, and the photoelectric conversion results are read out from the CCD 102. The output from the CCD 102 is converted to digital image data at an AFE (analog front end) (not shown) and the digital image data are then input to the image processing circuit 103. The image processing circuit 103 executes various types of image processing on the digital image data input thereto, and then records the image data having undergone the image processing into the SDRAM 107. The image processing circuit 103 also executes the “3 As (AE, AF and AWB)” operations and the relevant control during a shooting operation.

It is to be noted that the SDRAM 107, which is a built-in volatile memory, is used as a buffer memory where image data are temporarily recorded and as a work memory where a program is opened and variables used in the program are stored when the CPU 106 executes the program.

The JPEG codec 108 reads out image data recorded in the SDRAM 107, compresses the image data in the JPEG format and records the compressed image data back into the SDRAM 107. The CPU 106 reads out the image data (JPEG data) having been JPEG compressed from the SDRAM 107 and creates an image file (JPEG file) by appending various types of additional information (metadata) to the JPEG data. The CPU 106 transfers the JPEG file thus created to the memory card controller 110, which then records the JPEG file into a memory card 110a loaded in a memory card slot. Once the JPEG file is recorded, the photographing processing is completed.

It is to be noted that the LCD panel 105, mounted on the rear side of the camera, functions as an LCD viewfinder during a shooting operation, and that image data having undergone the image processing at the image processing circuit 103 are brought up on display at the LCD panel 105 with predetermined frame intervals. The photographer is thus able to compose the optimal image by viewing the display at the LCD panel 105.

Next, image data reproduction processing executed in the digital camera 100 is described. The CPU 106 reads out a JPEG file from the memory card 110a by controlling the memory card controller 110. The CPU 106 reads out the JPEG data in the JPEG file thus read out, decompresses the JPEG data and outputs the decompressed data to the image processing circuit 103. The image processing circuit 103 generates display image data by adjusting the resolution of the image to match the display resolution of the LCD panel 105 through resolution conversion executed on the decompressed data input thereto, and records the display image data into the SDRAM 107.

The display controller 104 reads out display image data from the SDRAM 107 and displays the display image data thus read out at the LCD panel 105.

The digital camera 100 in the embodiment is capable of generating an image file with a plurality of sets of JPEG data recorded therein, as well as the JPEG file generated through the standard photographing processing described above, i.e., an image file containing a single set of JPEG data recorded therein. When a plurality of sets of JPEG data are generated in a batch through a single photographing event, such as a continuous shooting operation, a panorama shooting session (operation) or an interval shooting operation, the CPU 106 stores the plurality of sets of JPEG data having been generated in a batch into a single image file. In other words, the CPU 106 creates an image file with the plurality of sets of JPEG data recorded therein.

In the description of the embodiment, an image file with a single set of main image data recorded therein will be referred to as an SP (single-picture) file, whereas an image file with a plurality of sets of main image data recorded therein will be referred to as an MP (multi-picture) file. It is to be noted that “MP file” is a term defined in the “CIPA standard: multi-picture format (CIPA DC-007-2009)” specifications. While the images contained in the MP file are referred to as “main images” in the description of the embodiment, the plurality of images contained in the MP file are each referred to as a “principal image” in the CIPA specifications. In addition, the SP file may contain thumbnail data and display image data corresponding to the main image data, in addition to the single set of main image data. The following description of the first through third embodiments is provided by assuming that main image data are JPEG data. The SP file may be formatted in compliance with, for instance, the Exif standard (exchangeable image file format for digital still cameras) of the known art.

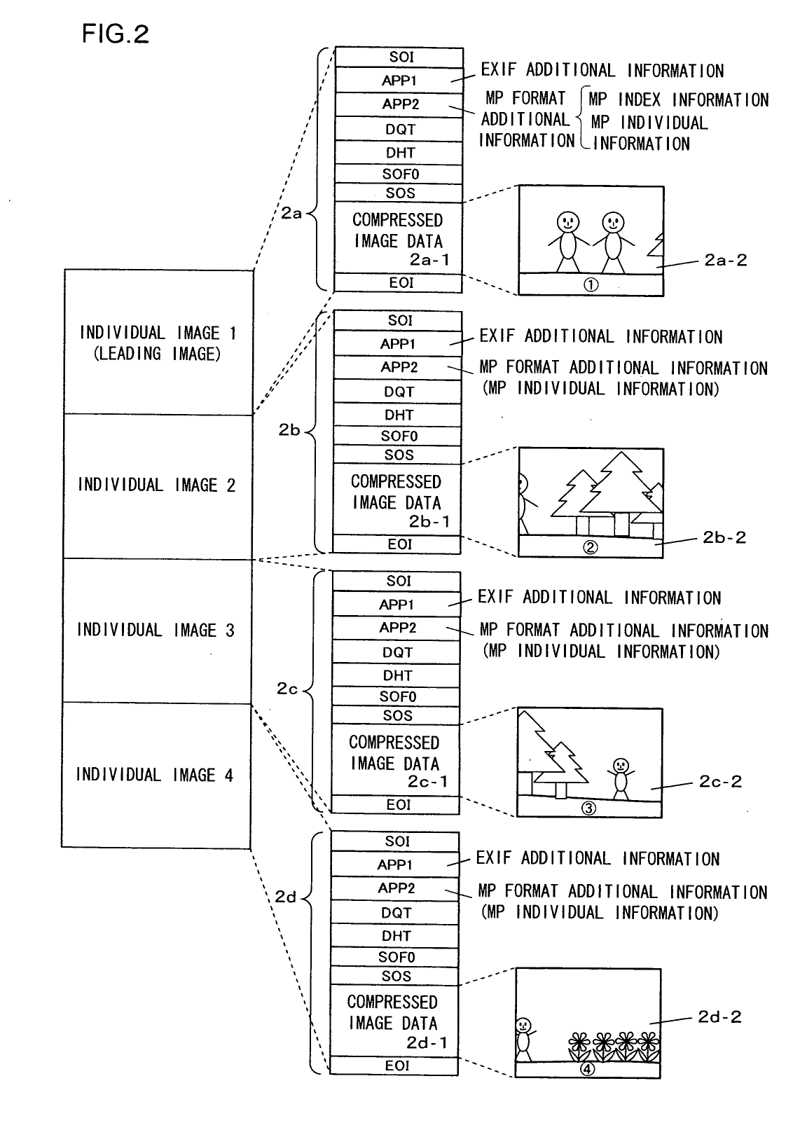

The MP file may be formatted as shown in FIG. 2. In the example presented in FIG. 2, image data expressing four images constituting a single panoramic image, obtained through a panorama shooting session, are stored in a single MP file. In more specific terms, four individual images 1 through 4 are recorded in the image file, with the individual images 2a through 2d each assuming the standard JPEG file data structure, as shown in FIG. 2.

Namely, Exif additional information and MP format-related additional information are recorded in APP1 and APP2 respectively in the data corresponding to each individual image. Information indicating the offset condition of each individual image (i.e., the relative address of the particular individual image, in relation to a reference position), the data size (the number of bytes) of the individual image and the like is also recorded as MP index information in APP2 corresponding to the leading image, i.e., the individual image 1. MP individual information pertaining to the leading image is also recorded in APP2 of the individual image 1. In addition, the MP individual information pertaining to each of the individual images other than the leading image is recorded in APP2 of the particular individual image.

The main image data mentioned earlier, i.e., the JPEG data, are recorded as compressed image data of each individual image. In the example presented in FIG. 2, image data expressing an image 2a-2 are recorded as compressed image data 2a-1 for the individual image 1, and image data expressing an image 2b-2 are recorded as compressed image data 2b-1 for the individual image 2. In addition, image data expressing an image 2c-2 are recorded as compressed image data 2c-1 for the individual image 3, and image data expressing an image 2d-2 are recorded as compressed image data 2d-1 for the individual image 4.

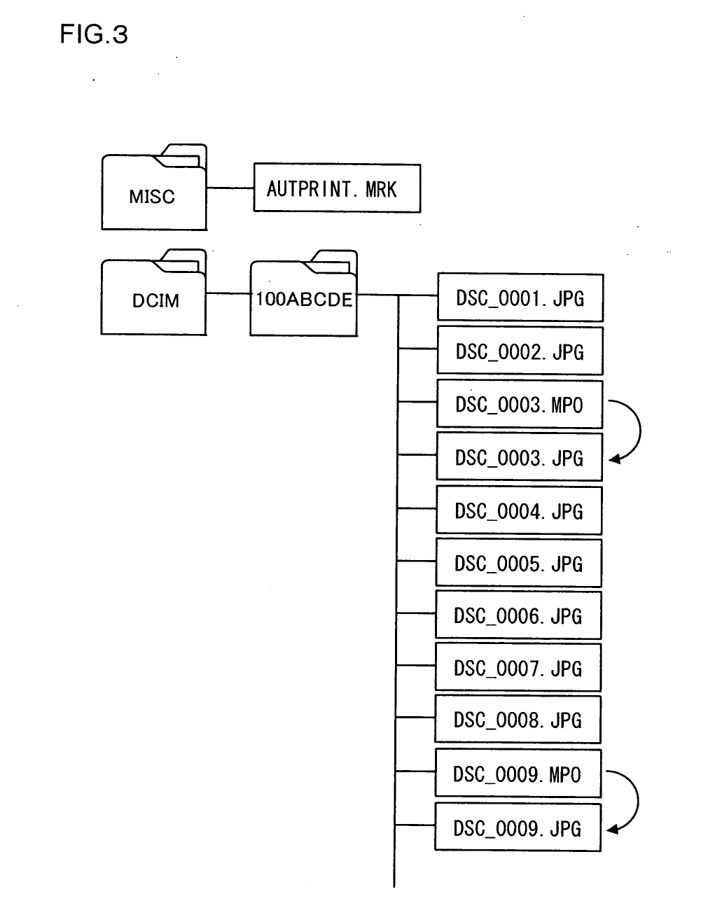

FIG. 3 shows how image files may be recorded in the memory card 110a. It is to be noted that the memory card 110a is normally formatted with the FAT file system, and the image files are recorded as FAT system files. In the example presented in FIG. 3, the image files are recorded with the DCF (design rule for camera file system) standard.

As shown in FIG. 3, image files are each recorded with a file name appended thereto in a “100ABCDE” directory within a “DCIM” directory, in compliance with the DCF standard. In the following description, the “DCIM” directory will be referred to as a “DCF image directory” and the “100ABCDE” directory will be referred to as a “DCF directory”. In addition, an image file recorded into the DCF directory must include a DCF file name made up with eight ASCII characters, and the last four characters in the DCF file name must be ASCII characters representing a decimal number between “0000” and “9999”.

The last four characters indicating a decimal value between “0000” and “9999” is referred to as a “file number”. While a file number that is different from all other file numbers is univocally appended to each image file under normal circumstances, one file number may be intentionally assigned to a plurality of image files to be grouped together. Such a group of image files sharing the same file number will be referred to as a “DCF object” in this description. It is to be noted that a file with an extension “.JPG” in FIG. 3 is an SP file, whereas a file with an extension “.MPO” in FIG. 3 is an MP file. In the example presented in FIG. 3, “DSC_{—}0003.JPG” and “DSC_{—}0003.MPO” together make up a DCF object and “DSC_{—}0009.JPG” and “DSC_{—}0009.MPO” also together make up a DCF object.

The embodiment allows the user to issue a print instruction by designating an image file (an MP file or an SP file) recorded in the memory card 110a as a print target. A print target image may be selected and a print instruction may be issued in conjunction with the selected target image in the digital camera 100 by adopting the DPOF (digital print order format) (registered trademark) method of the known art as the print instruction method. The embodiment is described below by assuming that a print instruction is issued by utilizing the DPOF (registered trademark). It is to be noted that the DPOF (registered trademark) is a definitive format that may be adopted in conjunction with print information (DPOF (registered trademark) information) used to enable automated printing on a printer or the like.

Once the user specifies a print target image, the desired quantity of prints and the like in the digital camera 100 and records DPOF (registered trademark) information indicating the print target image, the desired print quantity and the like together with the image file in a memory card 110a, the user is able to issue a print instruction in compliance with the DPOF (registered trademark). The user inserts the memory card 110a into a memory card slot of the printer to be used to print out the image. The printer reads out the DPOF (registered trademark) information from the memory card 110a loaded in the memory card slot and prints the image based upon the DPOF (registered trademark) information. It is to be noted that since the print processing executed at the printer by using the DPOF (registered trademark) information is of the known art, its explanation is not provided.

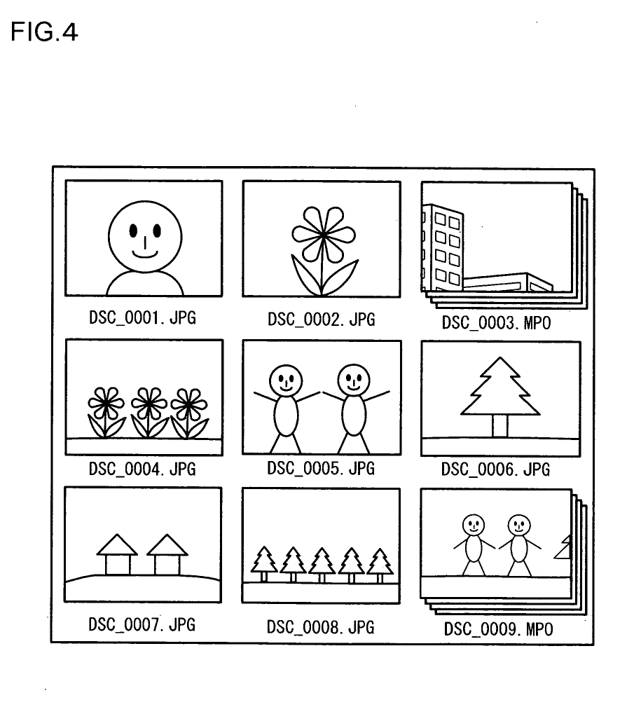

The user, wishing to issue a print instruction in compliance with the DPOF (registered trademark), needs to first issue a selection start instruction on the LCD panel 105 so as to start the selection of a print target image. In response to the image selection start instruction issued by the user, the CPU 106 executes the reproduction processing mentioned earlier so as to bring up a print instruction screen with an at-a-glance display of the images in the SP files and the images in the MP files recorded in the memory card 110a. The print instruction screen brought up on display at the LCD panel 105 may display the images stored in the SP files (extension: JPG) and the images expressed with JPEG data stored in the MP files (extension: MPO) as shown in FIG. 4.

In the display example for the print instruction screen presented in FIG. 4, the image expressed with a single set of JPEG data stored in each SP file is displayed for the particular SP file. “DSC_{—}0001.JPG”, “DSC_{—}0002.JPG”, “DSC_{—}0003.JPG”, “DSC_{—}0004.JPG”, “DSC_{—}0005.JPG”, “DSC_{—}0006.JPG”, “DSC_{—}0007.JPG” and “DSC_{—}0008.JPG” in FIG. 4 each represents an example of an image expressed with a single set of JPEG data stored in an SP file. The user selects an image in one of the SP files in the at-a-glance display with a cursor by operating a cross-key included in an operation member (not shown), and then presses an OK button (not shown) so as to specify the selected image as a print target.

An MP file, on the other hand, includes a plurality of sets of JPEG data stored therein and thus, the plurality of images need to be displayed in correspondence to the single MP file. In the embodiment, the images expressed with the plurality of sets of JPEG data stored in each MP file, e.g., “DSC_{—}0003.MPO”, or “DSC_{—}0009.MPO” in FIG. 4, are displayed as a stack of images so as to indicate that a plurality of sets of JPEG data are stored in the file.

The user is able to select with the cursor moved to one of the batches of MP file images each displayed as a stack of images by operating the cross-key included in the operation member (not shown). In this situation, the image displayed at the top of the selected image stack is selected. In addition, the user is able to switch images so as to display a different image at the top of the selected stack of images on display by operating the operation member. Namely, the user is able to display a different image at the top of the stack of images on display by operating the operation member so as to select an alternative image. In this case, too, the user is able to specify the selected image as a print target image by pressing the OK button (not shown).

In addition, although not shown, the print instruction screen includes a print quantity field displayed in correspondence to each of the images in the at-a-glance display, so as to allow the user to indicate, via the operation member, in the print quantity field the number of print copies he wishes to obtain in correspondence to each image having been specified as a print target.

In the embodiment, if the user specifies as a print target, an individual image included in an MP file having been generated as a result of a panorama shooting session, the CPU 106 asks the user whether he wishes to print the specified individual image alone or a panoramic image formed by stitching together (integrating) the various individual images contained in the MP file. Then, the CPU 106 prints the individual image or the panoramic image as instructed by the user in his response. It is to be noted that “MP category” information read out from the MP index information mentioned earlier indicates whether or not the plurality of images in the corresponding MP file have been obtained through a panorama shooting session.

For instance, if the image 2a-2 in the MP file shown in FIG. 2 is specified as a print target, the CPU 106 asks the user whether he wishes to print the image 2a-2 only, or to print the panoramic image formed by stitching the images 2a-2, 2b-2, 2c-2 and 2d-2 together. If the user indicates in his response that he wishes to print the image 2a-2 alone, the CPU 106 executes print instruction processing in compliance with DPOF (registered trademark) for the image 2a-2.

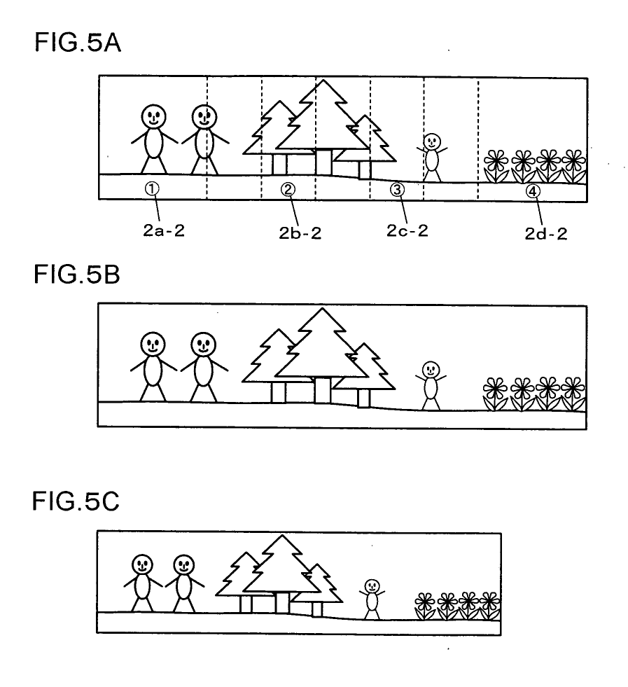

If, on the other hand, the user indicates in his response that he wishes to print the panoramic image, the CPU 106 creates a panoramic image such as that shown in FIG. 5B by stitching the images 2a-2, 2b-2, 2c-2 and 2d-2 together, as illustrated in FIG. 5A, and then executes the print instruction processing in compliance with the DPOF (registered trademark) for the panoramic image. It is to be noted that if the CPU 106 is able to obtain from the printer information indicating the paper size of the paper set at the printer, the CPU 106 may print the image by adjusting the size of the panoramic image having been created (by enlarging or reducing the panoramic image) in correspondence to the paper size.

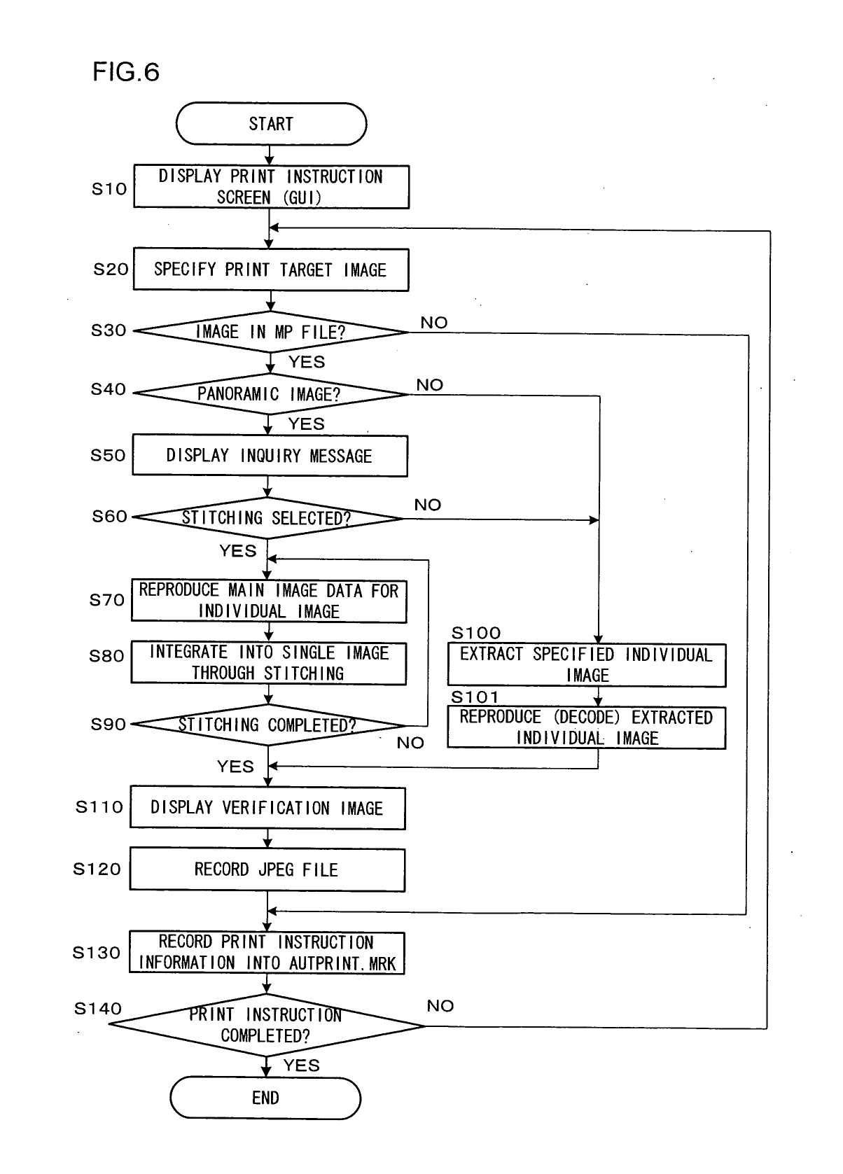

The following is a description of the print instruction processing executed in the embodiment in compliance with the DPOF (registered trademark), given in reference to FIG. 6. It is to be noted that the processing in FIG. 6 is executed by the CPU 106 as a program that is started up in response to a print instruction processing start instruction issued by the user.

In step S10, the CPU 106 brings up on display at the LCD panel 105 the print instruction screen shown in FIG. 4 and then the operation proceeds to step S20. In step S20, the CPU 106 specifies a print target image in response to an image selection operation performed by the user via the print instruction screen, and then the operation proceeds to step S30. In step S30, the CPU 106 identifies the image file containing the image having been specified in step S20 and makes a decision by referencing the header information in the identified image file as to whether or not the image file is an MP file.

If a negative decision is made in step S30, i.e., if the identified image file is an SP file, the operation proceeds to step S130 to be described later. However, if an affirmative decision is made in step S30, i.e., if the identified image file is an MP file, the operation proceeds to step S40. In step S40, the CPU 106 makes a decision as to whether or not the identified MP file contains images obtained through a panorama shooting session. If a negative decision is made in step S40, the operation proceeds to step S100. In step S100, the CPU 106 extracts the individual image file having been selected by the user via the print instruction screen, from the identified MP file, and then the operation proceeds to step S101. In step S101, the JPEG data expressing the individual image, having been extracted in step S100, are reproduced (decoded), before the operation proceeds to step S110 to be described in detail later.

If, on the other hand, an affirmative decision is made in step S40, the operation proceeds to step S50, in which the CPU 106 brings up on display an inquiry message asking the user if he wishes to print the specified individual image alone or print the panoramic image formed by stitching together (integrating) the various individual images included in the MP file. Subsequently, the operation proceeds to step S60, in which the CPU 106 makes a decision as to whether the user has selected “yes” or “no” with respect to stitching execution.

If it is decided in step S60 that the user has selected “no”, the operation proceeds to step S100, in which the CPU 106 extracts the individual image having been selected by the user via the print instruction screen, from the identified MP file, before proceeding to step S101. In step S101, the JPEG data expressing the individual image, having been extracted in step S100, are reproduced (decoded) and then the operation proceeds to step S110 to be described later. If, on the other hand, it is decided in step S60 that the user has selected “yes”, the operation proceeds to step S70, in which the CPU 106 reproduces (decodes) an individual image contained in the MP file and then the decoded data are stitched in step S80. Subsequently, the operation proceeds to step S90, in which the CPU 106 makes a decision as to whether or not all the individual images within the MP file have been stitched.

If a negative decision is made in step S90, the operation returns to step S70 to repeatedly execute the processing. If, on the other hand, an affirmative decision is made in step S90, the operation proceeds to step S110. In step S110, the CPU 106 brings up on display at the LCD panel 105 the print target image for purposes of user verification. Namely, it displays either the individual image having been reproduced (decoded) in step S101 or the panoramic image having been created through the data integration processing executed in steps S70 through S90. As a result, the user is able to verify the image to be printed beforehand.

Subsequently, the operation proceeds to step S120, in which the CPU 106 generates a JPEG file, i.e., an SP file containing the image data expressing the print target image and records the SP file into the memory card 110a. The CPU 106 in the embodiment creates the new SP file and assigns it with a file number matching the file number of the MP file used as the SP file generation source, so as to correlate the two image files by designating the SP file and the MP file as a DCF object. In the example presented in FIG. 3, “DSC_{—}0003.JPG” is an SP file generated based upon “DSC_{—}0003.MPO” and “DSC_{—}0009.JPG” is an SP file generated based upon “DSC_{—}0009.MPO”. Thus, the user is able to ascertain with ease the specific MP file having been used as an SP file generation source simply by checking the file name of the particular SP file and ultimately is able to manage image files with better ease. The operation then proceeds to step S130.

In step S130, job information, needed to print the print target SP file, is added to the DPOF (registered trademark) information (print instruction information) so as to print the specified image in compliance with the DPOF (registered trademark). While the DPOF (registered trademark) information, which is of the known art, does not require a detailed explanation, it is a data file assigned with a file name “AUTPRINT.MRK” recorded in the memory card 110a. “AUTPRINT.MRK” is recorded within a MISC folder within the memory card 110a, as shown in FIG. 3.

The operation then proceeds to step S140, in which the CPU 106 makes a decision as to whether or not the user has completed the print instruction via the print instruction screen. If a negative decision is made in step S140, the operation returns to step S20 to repeatedly execute the processing. If, on the other hand, an affirmative decision is made in step S140, the processing ends.

The following advantages are achieved through the first embodiment described above.

(1) If the user specifies a print target image expressed with individual image data contained in an MP file containing images obtained through a panorama shooting session, the CPU 106 stitches together the sets of individual image data and creates a single panoramic image. Then, it generates an SP file containing the panoramic image thus created and records the SP file into the memory card 110a. It further records the DPOF (registered trademark) information needed to print the image in the newly generated SP file. As a result, the user is able to have the panoramic image automatically printed simply by specifying an individual image.

(2) If the print target image file contains images obtained through a panorama shooting session, the CPU 106 issues an inquiry asking the user whether he wishes to print the specified individual image alone or print the panoramic image obtained by stitching together the individual images in the MP file. Then, it prints the individual image or the panoramic image as indicated by the user in his response. As a result, the user is allowed to freely choose whether to print either the panoramic image or the individual image.

(3) For purposes of verification, the CPU 106 brings up the image to be printed on display at the LCD panel 105. The user is thus able to verify the print target image prior to the actual printing operation.

(4) If the CPU 106 is able to obtain from the printer information indicating the paper size of the paper set at the printer, the CPU 106 first adjusts the size of the panoramic image having been created (by enlarging or reducing the panoramic image) in correspondence to the paper size and then prints the image in the adjusted size. Thus, the image can be printed in the optimal size matching the size of the paper set at the printer.

### Second Embodiment

In the first embodiment described above, the print instruction processing is executed in compliance with the DPOF (registered trademark). As an alternative, print processing may be executed in compliance with the PictBridge (registered trademark) system of the known art. When executing print processing executed in compliance with the PictBridge (registered trademark) system, the user, having connected to the digital camera 100 with a printer (not shown) via a USB cable, specifies a print target image at the digital camera 100. A print command and the print target image are then transmitted to the printer where a print JOB is executed in response. It is to be noted that in this situation, the digital camera 100 is connected via a USB port 109a with the printer through a USB connection, which is controlled by a USB controller 109.

In reference to the second embodiment, the print processing executed in compliance with the PictBridge (registered trademark) system is described. It is to be noted that while FIGS. 1 through 5C are also relevant to the second embodiment, the first embodiment has already been described in reference to the figures and thus, a repeated explanation is not provided.

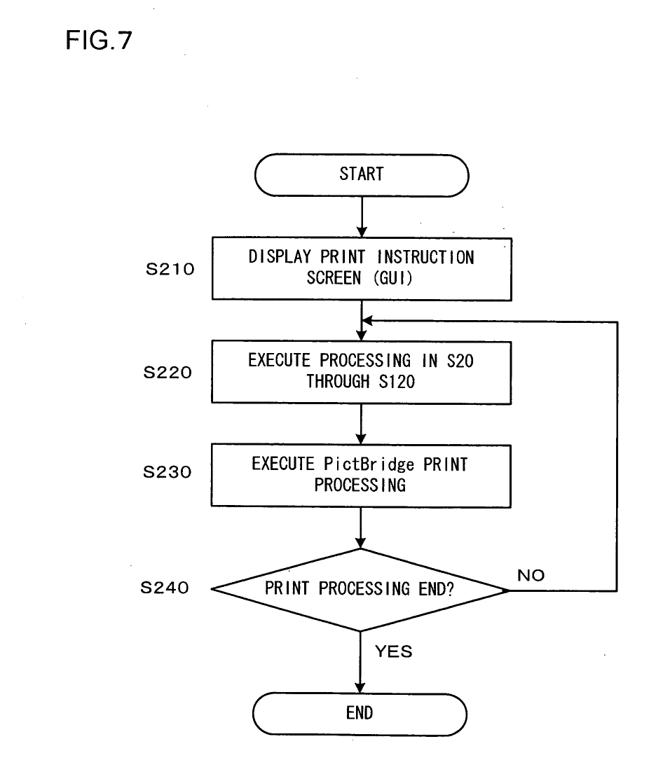

The following is a description of the print processing executed in the second embodiment in compliance with the PictBridge (registered trademark), given in reference to the flowchart presented in FIG. 7. The processing in FIG. 7 is executed by the CPU 106 based upon a program started up in response to a print instruction processing start instruction issued by the user.

In step S210, the CPU 106 brings up on display at the LCD panel 105 the print instruction screen shown in FIG. 4 and then the operation proceeds to step S220. In step S220, the CPU 106 executes the processing in step S20 through step S120 in FIG. 6 in reference to which the first embodiment has been described, before the operation proceeds to step S230. It is to be noted that while the SP file with the image data expressing the print target image stored therein is recorded into the memory card 110a in step S120 in FIG. 6, the SP file containing the image data expressing the print target image is stored into both the SDRAM 107 and the memory card 110a in this embodiment.

In step S230, the CPU 106 transmits a print command and the print target image file to the printer as described earlier. In this step, the CPU 106 reads out the SP file having been recorded, for instance, in the memory card 110a or in the SDRAM 107 in step S120 in FIG. 6 and transmits the SP file thus read out to the printer. If the SP file having been transmitted to the printer is recorded in the SDRAM 107, the CPU 106 deletes the SP file in the SDRAM 107 upon completing the transmission. The operation subsequently proceeds to step S240.

In step S240, the CPU 106 makes a decision as to whether or not the print processing has been completed. If a negative decision is made in step S240, the operation returns to step S220 to repeatedly execute the processing. However, if an affirmative decision is made in step S240, the processing ends.

In addition to the advantages of the first embodiment, the following advantage is achieved through the second embodiment described above. Namely, if the user specifies a print target image expressed with individual image data contained in an MP file holding images obtained through a panorama shooting session, the CPU 106 stitches together the sets of individual image data and creates a single panoramic image. Then, it generates an SP file containing the panoramic image thus created, records the SP file into the SDRAM or the memory card 110a, and issues a print instruction by transmitting the newly generated SP file to the printer. As a result, the user is able to have the panoramic image automatically printed simply by specifying an individual image.

### Third Embodiment

Processing executed when printing an MP file generated through a panorama shooting session has been described in reference to the first and second embodiments. In reference to the third embodiment, processing executed when reproducing an MP file obtained through a panorama shooting session is described. It is to be noted that while FIGS. 1 through 5C are also relevant to the third embodiment, a description has already been given in reference to the first embodiment and thus, a repeated explanation is not provided.

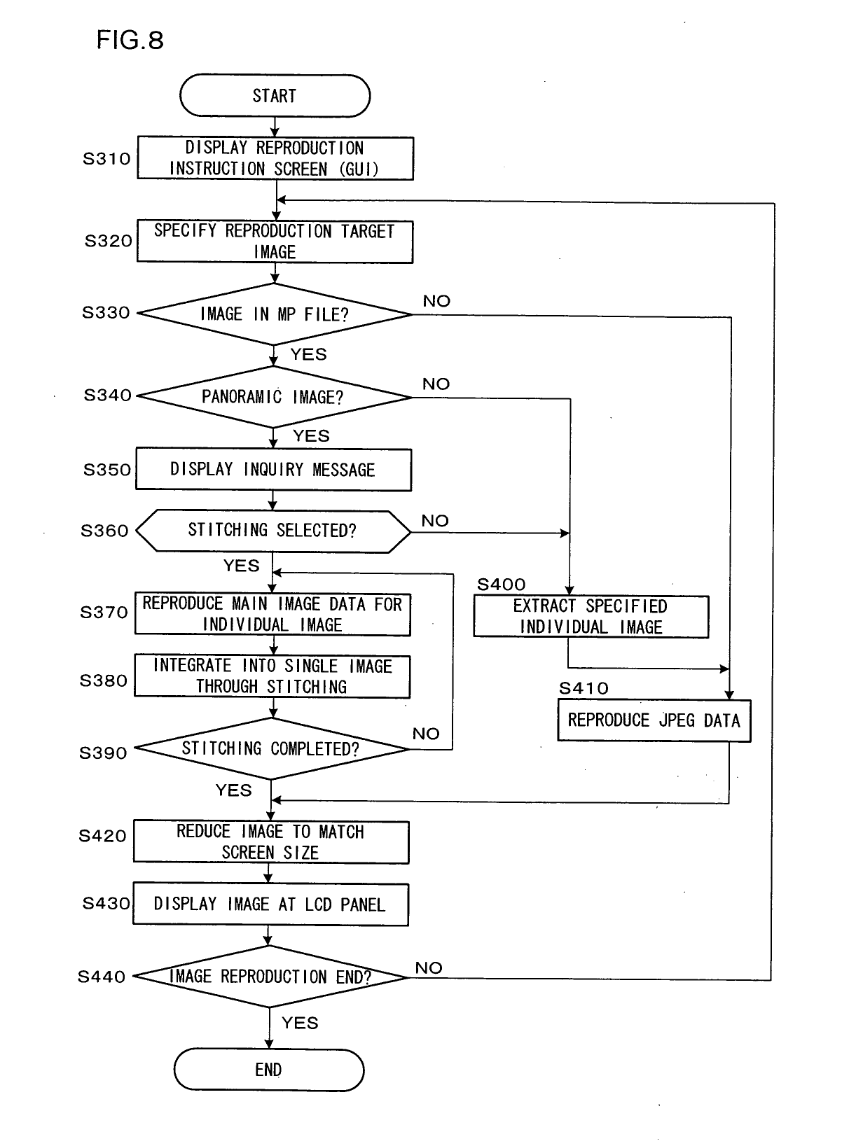

The following is a description of the image reproduction processing executed in the third embodiment, given in reference to the flowchart presented in FIG. 8. The processing in FIG. 8 is executed by the CPU 106 based upon a program started up in response to an image reproduction start instruction issued by the user. It is to be noted that the processing in FIG. 8 may be executed in the embodiment as the user sets the digital camera 100 in, for instance, a reproduction mode.

In step S310, the CPU 106 brings up on display at the LCD panel 105 a reproduction target image instruction screen to allow the user to specify a reproduction target image. The reproduction target image instruction screen brought up on display in this step may be similar to, for instance, the print instruction screen shown in FIG. 4. The operation then proceeds to step S320, in which the CPU 106 specifies a reproduction target image based upon an image selection operation performed by the user via the reproduction target instruction screen, before the operation proceeds to step S330.

In step S330, the CPU 106 identifies the image file containing the image having been specified in step S320 and makes a decision by referencing the header information in the identified image file as to whether or not the image file is an MP file. If a negative decision is made in step S330, i.e., if the identified image file is an SP file, the operation proceeds to step S410, in which the CPU 106 reproduces (decodes) the JPEG data in the identified SP file, and then the operation proceeds to step S420, to be described later. However, if an affirmative decision is made in step S330, i.e., if the identified image file is an MP file, the operation proceeds to step S340.

In step S340, the CPU 106 makes a decision as to whether or not the identified MP file contains images obtained through a panorama shooting session. If a negative decision is made in step S340, the operation proceeds to step S400. In step S400, the CPU 106 extracts the individual image, having been selected by the user on the reproduction target image instruction screen, from the identified MP file. The operation then proceeds to step S410, in which the JPEG data expressing the individual image, having been extracted in step S400, are reproduced (decoded), before the operation proceeds to step S420 to be described in detail later.

If, on the other hand, an affirmative decision is made in step S340, the operation proceeds to step S350. In step S350, the CPU 106 brings up on display an inquiry message asking the user if he wishes to reproduce the specified individual image alone or reproduce the panoramic image formed by stitching together (integrating) the various individual images included in the MP file. Subsequently, the operation proceeds to step S360, in which the CPU 106 makes a decision as to whether the user has selected “yes” or “no” with respect to stitching execution.

If it is decided in step S360 that the user has selected “no”, the operation proceeds to step S400, in which the CPU 106 extracts the individual image selected by the user via the reproduction target image instruction screen, from the identified MP file. The operation then proceeds to step S410, in which the CPU 106 reproduces (decodes) the JPEG data expressing the individual image extracted in step S400, and then the operation proceeds to step S420 to be described later.

If, on the other hand, it is decided in step S360 that the user has selected “yes”, the operation proceeds to step S370, in which the CPU 106 reproduces (decodes) an individual image contained in the MP file and then the decoded data are stitched in step S380. Subsequently, the operation proceeds to step S390, in which the CPU 106 makes a decision as to whether or not all the individual images within the MP file have been stitched.

If a negative decision is made in step S390, the operation returns to step S370 to repeatedly execute the processing. If, on the other hand, an affirmative decision is made in step S390, the operation proceeds to step S420. In step S420, the CPU 106 adjusts the data size of the reproduction target image, i.e., either the individual image data having been reproduced (decoded) in step S410 or the image data expressing the panoramic image having been created through the data integration processing executed in steps S370 through S390, so as to match the data size with match the screen size corresponding to the display resolution of the LCD panel 105 (by enlarging or reducing the image), and then the operation proceeds to step S430.

In step S430, the image data with the size thereof having been adjusted in step S420 are output and brought up on display at the LCD panel 105. The operation subsequently proceeds to step S440, in which the CPU 106 makes a decision as to whether or not the image reproduction has ended. The CPU 106 in the embodiment determines that the image reproduction has ended if the user has issued a reproduction mode end instruction. If a negative decision is made in step S440, the operation returns to step S320 to repeatedly execute the processing. If, on the other hand, an affirmative decision is made in step S440, the processing ends.

In addition to the advantages of the first and second embodiments described earlier, the following advantage is achieved through the third embodiment. Namely, the CPU 106 adjusts the size of the panoramic image it has generated so as to match the screen size corresponding to the display resolution of the LCD panel 105. As a result, the image can be reproduced in the optimal size matching the display resolution of the LCD panel 105.

—Variations—

It is to be noted that the digital cameras achieved in the embodiments as described above allow for the following variations.

(1) In the first and second embodiments, the CPU 106, upon determining that the print target image file has been generated through a panorama shooting session, issues an inquiry asking the user whether he wishes to print the specified individual image alone or print a panoramic image obtained by stitching together the various individual images contained in the MP file. Then, it prints the individual image or the panoramic image as instructed by the user in his response. However, the CPU 106, upon determining that the print target image file has been generated through a panorama shooting session, may automatically generate a panoramic image by stitching together the various individual images in the MP file and print the panoramic image thus generated without issuing an inquiry to the user. In this case, the user will only need to select any individual image in an MP file to have a panoramic image automatically printed.

As an alternative to issuing an inquiry to the user each time, the user may be allowed to select a setting for printing the individual image alone or a setting for printing the panoramic image generated by stitching together the various individual images in advance, and the CPU 106 may print the individual image or the panoramic image based upon the selected setting. In this case, the user is allowed to select in advance a desired setting indicating whether or not to have the panoramic image printed.

(2) If the reproduction target image file has been generated through a panorama shooting session, the CPU 106 in the third embodiment issues an inquiry asking the user whether he wishes to reproduce the specified individual image alone or reproduce a panoramic image obtained by stitching together the various individual images contained in the MP file, and then reproduces the individual image or the panoramic image as instructed by the user in his response to the inquiry. However, the CPU 106, upon determining that the reproduction target image file has been generated through a panorama shooting session, may automatically generate a panoramic image by stitching together the various individual images in the MP file together and reproduce the panoramic image thus generated without issuing an inquiry to the user. In this case, the user will only need to select any individual image in an MP file to have a panoramic image automatically reproduced.

As an alternative to issuing an inquiry to the user each time, the user may be allowed to select a setting for reproduction the individual image alone or a setting for reproducing the panoramic image generated by stitching together the various individual images in advance, and the CPU 106 may reproduce the individual image or the panoramic image based upon the selected setting. In this case, the user is allowed to select in advance a desired setting indicating whether or not to have the panoramic image reproduced.

(3) In the first and second embodiments described above, the CPU 106 adjusts the size of the panoramic image having been created through stitching so as to match the size of the paper set at the printer. In addition, in the third embodiment, the CPU 106 adjusts the size of the panoramic image having been created through stitching so as to match the screen size corresponding to the display resolution of the LCD panel 105. The image data expressing the panoramic image having undergone the size adjustment described above may then be added into the source MP file by the CPU 106. In such a case, the CPU 106 may record the image data expressing the panoramic image having undergone the size adjustment as the representative image for the MP file, e.g., as the leading individual image 1 in FIG. 2. Through these measures, the panoramic image generated for purposes of printing or reproduction can be recorded into the MP file by clearly indicating its relation to the source MP file. It is to be noted that the CPU 106 may record the panoramic image yet to undergo the size adjustment as an additional image into the MP file, instead.

(4) In the first through third embodiments described above, the images included in an MP file having been generated through a panorama shooting session are first stitched together and then the panoramic image resulting from stitching is printed or reproduced. However, the present invention may be adopted in conjunction with an MP file containing a plurality of individual images obtained through a shooting session (operation) other than a panorama shooting session, as long as the plurality of individual images have been captured in order to create a single image through synthesis, superposition, integration or the like.

(5) In the first embodiment described above, the print instruction processing is executed in the digital camera 100 in compliance with the DPOF (registered trademark). However, the print instruction processing in compliance with the DPOF (registered trademark) can be executed simply by recording a print target image file (SP file) and the DPOF (registered trademark) information into the memory card 110a, and thus, the present invention may be adopted in print instruction processing executed at a device other than the digital camera 100, e.g., a personal computer or an electronic device such as a portable telephone, with a built-in or external memory card slot.

(6) A description has been given in reference to the first through third embodiments on an example in which the present invention is adopted in the digital camera 100. However, the present invention is not limited to this example and it may be adopted in a device other than the digital camera 100, e.g., a personal computer or an electronic device such as a portable telephone.

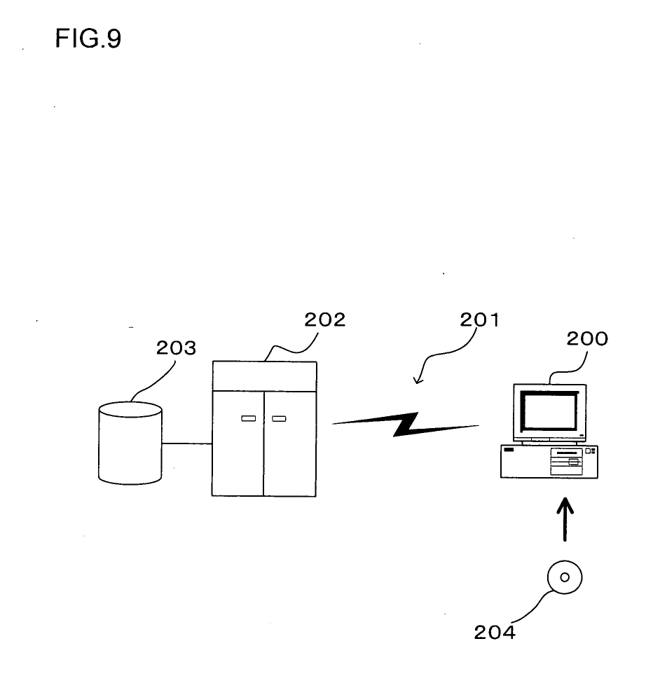

The programs described above shall may each be executed in a personal computer or the like by providing the personal computer or the like with a program recorded in a recording medium such as a CD-ROM, a USB memory (flash memory), a memory card or the like, or by providing the program as a data signal on the Internet or the like. FIG. 9 shows how the program may be provided. A personal computer 200 receives the program via a CD-ROM 204. The personal computer 200 is also capable of connecting with a communication line 201. A computer 202 is a server computer that provides the program stored in a recording medium such as a hard disk 203. The communication line 201 may be a communication network such as the Internet or it may be a dedicated communication line. The computer 202 transmits the program read out from the hard disk 203 to the personal computer 200 via the communication line 201. In other words, the program embodied as a data signal is transmitted on a carrier wave via the communication line 201. Explicitly, the program may be distributed as a computer-readable computer program product adopting any of various modes including a recording medium and a data signal (carrier wave).

(7) A description has been given in reference to the first through third embodiments on an example in which the main image data are constituted with JPEG data. However, the main data expressing an image designated as a print target at a personal computer or an electronic device such as a portable telephone, to be printed on a printer, may assume a format other than the JPEG format. A program enabling a personal computer or the like to execute such processing, too, can be provided in a recording medium, such as a CD-ROM, a USB memory (flash memory) or a memory card, or as a data signal on the Internet or the like.

(8) While the print instruction information indicates the print quantity in the first embodiment described earlier, the print instruction information may instead indicate the date/time or the like to be printed together with the image. Furthermore, the print instruction information may also indicate a specific position at which the date/time is to be printed in the image, e.g., the upper left corner, the upper right corner, the lower left corner or the lower right corner of the image. It is to be noted that a setting indicating a specific type of print instruction information to be created may be selected before the print target image is selected or it may be selected immediately before the print instruction information is written (immediately before step S130 in FIG. 6).

As long as the features characterizing the present invention are not compromised, the present invention is not limited to any of the specific structural particulars described in reference to the embodiments. In addition, any of the embodiments described above may be adopted in combination with a plurality of variations.

What is claimed is:

1. An electronic device, comprising:
a specifying unit that specifies image data to be designated as a print target;
an image generation unit that generates a single image as a print target image based upon a plurality of sets of image data when the specifying unit specifies as the print target a set of image data contained in a first image file that includes the plurality of sets of image data for constituting the single image;
an image file generation unit that generates a second image file containing the print target image having been generated by the image generation unit;
an image file recording unit that records the second image file having been generated by the image file generation unit, into a storage medium; and
a print information recording unit that generates print information to be used when printing the print target image and records the print information into the storage medium.

2. An electronic device, comprising:
a specifying unit that specifies image data to be designated as a print target;
an image generation unit that generates a single image as a print target image based upon a plurality of sets of image data when the specifying unit specifies as the print target a set of image data contained in a first image file which includes the plurality of sets of image data for constituting the single image;
an image file generation unit that generates a second image file containing the print target image having been generated by the image generation unit;
an image file recording unit that records the second image file having been generated by the image file generation unit, into a storage medium; and
a print instruction unit that issues a print instruction so as to engage a printer device to print the print target image by transmitting the second image file having been recorded by the image file recording unit, to the printer device.

3. An electronic device according to claim 1, further comprising:
a setting unit that selects a setting indicating whether or not to generate the print target image based upon the plurality of sets of image data, wherein:
the image generation unit generates the print target image based upon the plurality of sets of image data when the setting unit selects a setting indicating that the print target image is to be generated, and the image generation unit designates the set of image data having been specified by the specifying unit as the print target image when the setting unit selects a setting indicating that the print target image is not to be generated.

4. An electronic device according to claim 1, wherein:
when the specifying unit has specified as the print target one of the plurality of sets of image data in the first image file, the image generation unit issues an inquiry to a user asking whether the user wishes to have the print target image generated based upon the plurality of sets of image data, generates the print target image based upon the plurality of sets of image data if the user allows generation of the print target image, and designates the set of image data having been specified by the specifying unit as the print target image if the user disallows generation of the print target image.

5. An electronic device according to claim 1, further comprising:
an image display unit that displays at a display device the print target image having been generated by the image generation unit.

6. An electronic device according to claim 1, wherein:
the image file recording unit generates the second image file after adjusting a size of the print target image in correspondence to a size of paper on which the print target image is to be printed.

7. An electronic device according to claim 5, wherein:
the image file recording unit generates the second image file after adjusting a size of the print target image in correspondence to display resolution of the display device.

8. An electronic device according to claim 6, further comprising:
an additional recording unit that additionally records image data expressing the print target image having undergone size adjustment into the first image file having been used as a generation source when generating the print target image.

9. An electronic device according to claim 8, wherein:
a set of image data is recorded as a representative image in the first image file; and
the additional recording unit records the image data expressing the print target image having undergone the size adjustment as the representative image.

10. An electronic device according to claim 2, further comprising:
a setting unit that selects a setting indicating whether or not to generate the print target image based upon the plurality of sets of image data, wherein:
the image generation unit generates the print target image based upon the plurality of sets of image data when the setting unit selects a setting indicating that the print target image is to be generated, and the image generation unit designates the set of image data having been specified by the specifying unit as the print target image when the setting unit selects a setting indicating that the print target image is not to be generated.

11. An electronic device according to claim 2, wherein:
when the specifying unit has specified as the print target one of the plurality of sets of image data in the first image file, the image generation unit issues an inquiry to a user asking whether the user wishes to have the print target image generated based upon the plurality of sets of image data, generates the print target image based upon the plurality of sets of image data if the user allows generation of the print target image, and designates the set of image data having been specified by the specifying unit as the print target image if the user disallows generation of the print target image.

12. An electronic device according to claim 2, further comprising:
an image display unit that displays at a display device the print target image having been generated by the image generation unit.

13. An electronic device according to claim 2, wherein:
the image file recording unit generates the second image file after adjusting a size of the print target image in correspondence to a size of paper on which the print target image is to be printed.

14. An electronic device according to claim 12, wherein:
the image file recording unit generates the second image file after adjusting a size of the print target image in correspondence to display resolution of the display device.

15. An electronic device according to claim 13, further comprising:
an additional recording unit that additionally records image data expressing the print target image having undergone size adjustment into the first image file having been used as a generation source when generating the print target image.

16. An electronic device according to claim 15, wherein:
a set of image data is recorded as a representative image in the first image file; and
the additional recording unit records the image data expressing the print target image having undergone the size adjustment as the representative image.

17. A camera, comprising:
an image acquisition unit that obtains image data by capturing a subject image; and
an electronic device according to claim 1.

18. A camera, comprising:
an image acquisition unit that obtains image data by capturing a subject image; and
an electronic device according to claim 2.

19. An electronic device, comprising:
a specifying unit that specifies image data;
an image generation unit that generates a single image based upon a plurality of sets of image data when the specifying unit specifies a set of image data contained in a first image file that includes the plurality of sets of image data for constituting the single image;
an image file generation unit that generates a second image file containing the image having been generated by the image generation unit; and
an image file recording unit that records the second image file having been generated by the image file generation unit, into a storage medium.

20. A computer program product that enables a computer to execute:
a specifying step of specifying image data;
an image generation step of generating a single image based upon a plurality of sets of image data when one set of image data contained in a first image file that includes the plurality of sets of image data for constituting the single image, is specified through the specifying step;
an image file generation step of generating a second image file containing the image having been generated through the image generation step; and
an image file recording step of recording the second image file having been generated through the image file generation step into a storage medium.
